(19) United States
(12) Patent Application Publication
(10) Pub. No.: US 2008/0131675 A1
(43) Pub. Date: Jun. 5, 2008

(54) Thermoformable Multilayer Film

(75) Inventors: Tobias Fackler, Legau (DE); Christian Schweitzer, Obergunzburg (DE); Walter Bernig, Durach (DE); Bernard Dujardin, Brussel (BE)

Correspondence Address: NORRIS, MCLAUGHLIN & MARCUS, P.A., 875 THIRD AVE, 18TH FLOOR, NEW YORK, NY, 10022, US

(73) Assignee: CFS Kempten GmbH, Kempten (DE)

(21) Appl. No.: 11/719,290

(22) PCT Filed: Nov. 16, 2005
(86) PCT No.: PCT/EP05/56025

§ 371 Date: Jul. 31, 2007

(30) Foreign Application Priority Data
Nov. 16, 2004 (DE) 10 2004 055 323.8
Nov. 22, 2004 (DE) 10 2004 056 225.3

(51) Int. Cl. B32B 7/02; B32B 37/00

(52) U.S. Cl. 428/213; 264/171.1

(57) ABSTRACT

Thermoformable multilayer film having a barrier layer the thickness of which is less than 3% of the total multilayer thickness.

The invention relates to a thermoformable multilayer film, which is suitable as a packaging material, in particular for the packaging of foodstuffs.

Foodstuffs packaging containing a protective gas atmosphere, such as so-called “MAP packaging” (modified atmosphere packaging), is used increasingly widely, for example for the packaging of fresh meat.

Known packaging of this type consists of two packaging elements, between which the product to be packaged is arranged. The first packaging element is generally shaped into a tray, i.e. a dish-shaped, open receptacle, which accommodates the product to be packaged. Such trays are conventionally shaped by thermoforming of suitable films. To close the packaging, the tray is covered by the second packaging element, such as e.g. a lid, so producing a closed receptacle in which the product to be packaged is located. The two packaging elements are connected together by means of a peripheral seal seam, wherein the air in the receptacle is preferably replaced prior to the sealing operation by a protective gas atmosphere. The material, which forms the first packaging element (tray), has to have a certain mechanical strength and dimensional stability in the temperature range conventional for the particular application, so that the packaging offers satisfactory protection for the packaged product during transport and storage. The material which forms the second packaging element (lid) is usually transparent, such that the packaged product located thereunder is readily visible.

The requirements made of a thermoformable packaging material are multi-faceted. On the one hand, the packaging material has to be readily processable, i.e. it has to be capable of quick, reliable deformation using conventional thermoforming stations, while on the other hand it has to display satisfactory rigidity only a short time after the thermoforming process, so as not to lose the predetermined tray shape after leaving the thermoforming station.

A measure of the quality of the packaging material is the width of the processing window. The processing window is described in terms of the packaging speed and the thermoforming temperature. What is wanted is a high packaging speed with a very wide thermoforming temperature range. The thermoforming temperature is the temperature of the heating zones established on the machine. Low thermoforming temperatures allow the speed of the packaging machine to be increased and the thermal stress to which the packaging material is exposed to be reduced. Another desirable feature is a high wall thickness of the thermoformed packaging material at critical points, in particular also at the corners of the thermoformed packaging element.

Particular difficulties arise if the packaging material needs to be transparent, so that the packaged product can also be seen from the bottom of the packaging so that its condition may be monitored. In this case, not only do the packaging materials need to be capable of deformation on conventional thermoforming stations at a high cycle rate and over a very wide range of thermoforming temperatures, but also the optical properties, i.e. in particular high transparency, must additionally be impaired as little as possible (relative to a constant material thickness).

In addition, at least the surface of the packaging material facing the inside of the tray needs to be heat-sealable, so that subsequently, after the introduction of the product to be packaged, the packaging may be closed in airtight manner by sealing the lid to the tray. Furthermore, the packaging material used must satisfy the toxicity standards relating to the packaging of foodstuffs.

In the prior art, thermoformable multilayer films are known which are produced by coextrusion. However, production conditions require the individual layers to display a certain minimum layer thickness in comparison with the overall layer thickness of the multilayer film. Thus, there are in particular difficulties in producing by coextrusion multilayer films in which an individual layer has a layer thickness of less than 5%, in particular of less than 3% of the overall layer thickness of the multilayer film.

Installations for flat film coextrusion are commercially available, in which the polymers for the individual layers are brought together in a so-called “feedblock” before being extruded through a flat film die to yield the multilayer film. In such a feedblock the individual layer thicknesses are fixed and thus the relative ratio of the individual layer thicknesses to one another. Temperature control in the feedblock is limited, however, such that the extrusion temperature cannot be individually adjusted for each individual layer. Consequently, differences in the theological properties of the polymers on which these individual layers are based cannot be compensated to the desired degree even by varying individually the temperature of the individual polymers. As a consequence, such installations cannot be used to produce thin and homogeneous individual layers if comparatively thick outer layers are also extruded at the same time.

This situation caused by production conditions consequently arises in particular when films with more than 5, preferably up to 9 individual layers are produced by coextrusion, wherein it would be sufficient for only some layers to have a comparatively large layer thickness and other layers to have a minimal layer thickness.

For instance, multilayer films often contain layers of specific materials which, in order to fulfil their function within the multilayer film, could be present per se in distinctly lower layer thicknesses than is possible under coextrusion production conditions. For example, multilayer films for the packaging of foodstuffs under a protective gas atmosphere generally comprise a barrier layer, in order to ensure that the packaging displays satisfactory gas- and/or aroma-tightness. In order to fulfil this function, all that would conventionally be necessary per se would be layer thicknesses of below 10 μm, preferably below 5 μm. However, if the barrier layer is a constituent of a multilayer film with a relatively large overall layer thickness, e.g. of a few hundred μm, it is impossible or possible only with great difficulty to adjust the layer thickness of these barrier layers to the minimum amount of a few μm necessary for them to fulfil their function by coextrusion using the above-described installations for flat film extrusion.

Instead, the barrier layers in such multilayer films conventionally exhibit a per se unnecessarily large layer thickness, which undesirably limits the flexibility of the multilayer film. Furthermore, the polymers on which the barrier layer is based are comparatively cost-intensive, such that unnecessarily large layer thicknesses are undesirable due to the concomitant material consumption. The production of such multilayer films is made more difficult if the barrier layer is to be embedded between two polyamide layers.

Consequently, the properties of prior art multilayer films are not ideal and they are difficult to process, in particular on so-called form-fill-seal packaging machines, which are equipped with contact heating units.

There is therefore a need for a thermoformable packaging material which has advantages over the materials of the prior art.

The object of the invention is to provide an improved packaging material. In particular, the packaging material needs to be thermoformable and thus suitable for the production of packaging trays for foodstuffs, wherein the mechanical properties need to satisfy at least high standards, in order to ensure problem-free processability on conventional packaging machines.

This object is achieved by the provision of a thermoformable multilayer film comprising
a backing layer (T) based on a thermoplastic polyolefin, thermoplastic olefin copolymer or mixture thereof,
an interlayer (Z) based on a thermoplastic polyolefin, thermoplastic olefin copolymer or mixture thereof,
a bonding layer (V),
a coupling agent layer (HV-1) and/or a polyamide layer (PA-1),
a gas- and/or aroma-tight barrier layer (B),
a polyamide layer (PA-2) and/or a coupling agent layer (HV-2), and
a heat-sealing layer (S),
   wherein the layer thickness of the barrier layer (B) amounts to less than 3.0% of the overall layer thickness of the multilayer film.

It has been found that the multilayer films according to the invention are suitable for thermoforming MAP packaging trays. The thermoformable multilayer films according to the invention have good mechanical and optical properties, which are substantially not impaired by the thermoforming process, and are suitable from a toxicological standpoint for the packaging of foodstuffs. Sealing and barrier properties may be varied within broad limits depending on the intended use of the multilayer film, without the excellent thermoformability and the optical properties consequently being impaired. In particular, individual layers display a sufficiently small layer thickness despite further layers with a relatively large layer thickness.

In a preferred embodiment of the multilayer films according to the invention, the layer thickness of the barrier layer (B) amounts to less than 2.5%, more preferably less than 2.0%, still more preferably less than 1.5%, still more preferably less than 1.0%, most preferably less than 0.75% and in particular less than 0.5% of the overall layer thickness of the multilayer film.

The multilayer films according to the invention are thermoformable. For the purposes of the invention, the term “thermoformable” defines a material which may be “thermoformed” under exposure to heat on a suitable apparatus, i.e. may be shaped under exposure to pressure (and/or a vacuum), for example to yield an open receptacle, preferably a tray. The material is a material having thermoplastic properties, such that it is deformable when heated but exhibits sufficient dimensional stability at room temperature, such that the shape (e.g. tray) predetermined by thermoforming is substantially also retained after introduction of the product to be packaged.

In a preferred embodiment, the multilayer film according to the invention comprises a coupling agent layer (HV-1) and a coupling agent layer (HV-2). In another preferred embodiment, the multilayer film according to the invention comprises a polyamide layer (PA-1) and a polyamide layer (PA-2). Particularly preferably, both a polyamide layer (PA-1), and a coupling agent layer (HV-1) are present; it is likewise particularly preferable for both a polyamide layer (PA-2) and a coupling agent layer (HV-2) to be present.

In a particularly preferred embodiment, the multilayer film according to the invention comprises
a backing layer (T),
an interlayer (Z),
a bonding layer (V),
a coupling agent layer (HV-1),
a polyamide layer (PA-1),
a barrier layer (B),
a polyamide layer (PA-2),
a coupling agent layer (HV-2), and
a heat-sealing layer (S).

The sequence of the individual layers within the multilayer film preferably corresponds to the sequence in which they are named in the above list, i.e. (T)//(Z)//(V)//(HV-1)//(PA-1)//(B)//(PA-2)//(HV-2)//(S). The symbol “//” denotes the interface between two adjacent layers. It is not absolutely necessary for two layers separated by “//” to succeed one another directly, i.e. to touch one another—it is also possible for further layers to be inserted.

Multilayer films with the following layer sequence are particularly preferred:
(T)//(Z)//(V)//(HV-1)//(B)//(HV-2)//(S),
(T)//(Z)//(V)//(PA-1)//(B)//(PA-2)//(S),
(T)//(Z)//(V)//(HV-1)//(B)//(PA-2)//(S),
(T)//(Z)//(V)//(PA-1)//(B)//(HV-2)//(S);
(T)//(Z)//(V)//(HV-1)//(PA-1)//(B)//(HP-2)//(S),
(T)//(Z)//(V)//(HV-1)//(PA-1)//(B)//(PA-2)//(S),
(T)//(Z)//(V)//(HV-1)//(B)//(PA-2)//(HV-2)//(S),
(T)//(Z)//(V)//(PA-1)//(B)//(PA-2)//(HV-2)//(S); and
(T)//(Z)//(V)//(HV-1)//(PA-1)//(B)//(PA-2)//(HV-2)//(S).

In a preferred embodiment, the multilayer film according to the invention exhibits an overall layer thickness of at least 100 μm, more preferably of at least 125 μm, still more preferably of at least 150 μm, most preferably of at least 175 μm and in particular of at least 200 μm. Preferably, the overall layer thickness is in the range from 100 to 3000 μm, more preferably 125 to 2500 μm, still more preferably 150 to 1500 μm, most preferably 175 to 1200 μm and in particular 200 to 1100 μm. In one preferred embodiment, the overall layer thickness of the multilayer film according to the invention amounts to at least 210 μm, 220 μm, 230 μ, 240 μm, 250 μm, 275 μm, 300 μm, 325 μm, 350 μm, 375 μm, 400 μm, 425 μm, 450 mm, 475 μm, 500 μm, 525 μm, 550 μm, 575 μm or at least 600 μm.

The backing layer (T) and the interlayer (Z) of the multilayer film according to the invention are based, identically or differently, on a thermoplastic polyolefin, thermoplastic olefin copolymer or mixture thereof.

The backing layer (T) is preferably based on a thermoplastic polymer, which has a melting temperature of at most 170° C., more preferably of at most 160° C., particularly preferably of 110° C. to 170° C. Particularly preferably, the backing layer (T) is based on polyethylene, in particular polyethylene with a density of at most 0.92 g/cm³, polypropylene (PP), ethylene copolymer, in particular ethylene/vinyl acetate copolymer and/or propylene copolymer. Particularly preferably, the backing layer (T) is based on polypropylene, a propylene copolymer (in particular a propylene random copolymer or a propylene block copolymer) or a mixture thereof.

The backing layer (T) preferably has a thickness of from 100 to 800 μm, more preferably 120 to 700 μm, still more preferably 140 to 600 μm, most preferably 150 to 300 μm and in particular of from 160 to 275 μm.

The interlayer (Z) is preferably based on a thermoplastic polymer, which has a melting temperature of at most 170° C., more preferably at most 160° C., particularly preferably of from 110° C. to 170° C. Particularly preferably, the interlayer (Z) is based on polyethylene, in particular polyethylene with a density of at most 0.92 g/cm³, polypropylene (PP), ethylene copolymer, in particular ethylene/vinyl acetate copolymer and/or propylene copolymer. Particularly preferably, the interlayer (Z) is based on polypropylene, a propylene copolymer (in particular a propylene random copolymer or a propylene block copolymer) or a mixture thereof.

The interlayer (Z) preferably has a thickness of from 50 to 750 μm, more preferably 100 to 500 μm, still more preferably 125 to 475 μm, most preferably 150 to 450 μm and in particular of from 175 to 425 μm.

In a preferred embodiment of the multilayer film according to the invention, the backing layer (T) and the interlayer (Z) are based on the same polyolefin, olefin copolymer or on the same mixture thereof. Methods are known to a person skilled in the art as to how two adjacent layers of the same polymer composition may be identified as individual, separate layers. A suitable method is for example microscopy with microtome section.

In a preferred embodiment of the multilayer film according to the invention, the layer thickness of the interlayer (Z) amounts to at least 10% of the layer thickness of the backing layer (T). More preferably, the layer thickness of the interlayer (Z) amounts to at least 50% of the layer thickness of the backing layer (T), still more preferably the interlayer (Z) is at least as thick as the backing layer (T). In a preferred embodiment, the ratio of the layer thickness of the interlayer (Z) to the layer thickness of the backing layer (T) is in the range from 0.1:1 to 20:1, more preferably 0.5:4 to 15:1, still more preferably 1:1 to 10:1, most preferably 1:1 to 5:1 and in particular 1:1 to 3:1.

The bonding layer (V) of the multilayer film according to the invention is preferably based on a polymer selected from the group consisting of polyamides (PA), copolyamides (CoPA), polyolefins (PO), olefin copolymers (CoPO), polystyrene (PS), polyethylene terephthalate (amorphous PET or crystalline PET) or polyvinyl chloride (PVC). Particularly preferably, the bonding layer (V) is based on a thermoplastic polyolefin, thermoplastic olefin copolymer or mixture thereof. Particular preference is given to polypropylene, a propylene copolymer (in particular a propylene random copolymer or a propylene block copolymer), or a mixture thereof.

The bonding layer (V) preferably has a thickness of from 1.0 to 100 μm, more preferably 2.0 to 50 μm, still more preferably 3.0 to 25 μm, most preferably 4.0 to 20 μm and in particular of from 5.0 to 15 μm.

In a preferred embodiment, the backing layer (T), the interlayer (Z) and also the bonding layer (V) are based, identically or differently, on a thermoplastic polyolefin, a thermoplastic olefin copolymer or mixture thereof particularly preferably on polypropylene or a propylene copolymer. It has surprisingly been found that the thermoformability of the multilayer films according to the invention may be varied over a wide range by means of the melt flow index of the polymers on which the backing layer (T), the interlayer (Z) and the bonding layer (V) are based. The thermoforming temperature may also be varied in this way. The polymers on which the backing layer (T), the interlayer (Z) and the bonding layer (V) are based may be characterised by means of their melt flow rate MFR, which is measured according to the invention preferably to DIN ISO 1133 at 190° C. and 2.16 kg. The polymers on which the backing layer (T), the interlayer (Z) and the bonding layer (V) are based are preferably polymers with a comparatively high MFR, i.e. low viscosity. Preferably, the backing layer (T) is based on a polymer which has a lower melt flow rate than the polymer on which the interlayer (Z) is based. Particularly preferably, the melt flow rates of the polymers on which the layers (T), (Z) and (V) are based behave according to the following sequence:
MFR(T)<MFR(Z)<MFR(V) or
MFR(T)<MFR(V)<MFR(Z),
   wherein the melt flow rates MFR are in each case determined to DIN ISO 1133 at 190° C.) and 2.16 kg.

In a preferred embodiment, the ratio of the melt flow rate of the polymer on which the backing layer (T) is based (MFR(T)) to the melt flow rate of the polymer on which the interlayer (Z) is based (MFR(Z)) is in the range from 1:1.1 to 1:20, more preferably 1:1.2 to 4:10, still more preferably 1:1.3 to 1:5, most preferably 1:1.4 to 1:4 and in particular 1:1.5 to 1:3, wherein the melt flow rates MFR are in each case determined to DIN ISO 1133 at 190° C. and 2.16 kg. It has surprisingly been found that the optical properties of the multilayer films according to the invention are improved in comparison with multilayer films which, although they contain a backing layer (T), contain no interlayer (Z) and no bonding layer (V). If, in particular, the multilayer films according to the invention are transparent, thermoforming has no or only an insignificant negative influence on transparency (relative to a constant material thickness, i.e. taking account of the thinning of the packaging material in the Course of deformation).

The barrier layer (B) of the multilayer film according to the invention is gas- and/or aroma-tight. Suitable methods for measuring oxygen- or aroma-tightness are known to a person skilled in the art. Preferably, the gas-tightness of the multilayer film according to the invention, determined to DIN 53380, amounts to less than 5.0, more preferably less than 4.0 and in particular less than 2.0 [cm³/m² d bar O₂].

The barrier layer (B) is preferably based on at least one polymer selected from the group comprising ethylene/vinyl alcohol copolymer (EVOH), polyvinylidene chloride/vinylidene chloride copolymer, polyester and polyamide, preferably on ethylene/vinyl alcohol copolymer. The ethylene/vinyl alcohol copolymer is obtained by partial saponification of an ethylene/vinyl acetate copolymer, wherein the degree of saponification is preferably between 25 and 50 mol %, more preferably between 35 and 45 mol %. The barrier layer (B) needs to largely impermeable both to oxygen and to water vapour. This property preferably also needs to be maintained even if the multilayer film is used at elevated temperatures.

The barrier layer (B) preferably has a thickness of from 0.5 to 50 μm, more preferably 1.0 to 20 μm, still more preferably 1.5 to 15 μm, most preferably 2.0 to 10 μm and in particular of from 2.5 to 7.5 μm. In a preferred embodiment, the layer thickness of the barrier layer (B) preferably amounts to at most 10 μm, more preferably at most 7.5 μm, still more preferably at most 5.0 μm, most preferably at most 4.0 μm and in particular at most 3.0 μm.

The optionally present coupling agent layers (HV-1) and/or (HV-2) of the multilayer film according to the invention are preferably based, identically or differently, on a mixture of polyolefins and/or olefin copolymer, preferably selected from the group consisting of polyethylene, such as low density polyethylene (LDPE) or high density polyethylene (HDPE), polypropylene (PP), maleic anhydride copolymer (MAH copolymer, grafted) and/or ethylene/vinyl acetate copolymer. Preference is given to anhydride-modified polyethylene, acid copolymers of ethylene, acid-modified ethylene vinyl acetate, acid-modified ethylene (meth)acrylate, anhydride-modified ethylene (meth)acrylate, anhydride-modified ethylene vinyl acetate, acid-/acrylate-modified ethylene vinyl acetate and a polymer blend containing at least one of the above-stated polymers. MAH copolymers are particularly preferred.

The optionally present coupling agent layers (HV-1) and/or (HV-2) preferably exhibit the same or different layer thicknesses of from 1.0 to 25 μm, more preferably 1.2 to 15 μm, still more preferably 1.5 to 10 μm, most preferably 1.8 to 7.5 μm and in particular of from 2.0 to 5.0 μm.

The optionally present polyamide layers (PA-1) and/or (PA-2) of the multilayer film according to the invention are preferably based, identically or differently, on a polyamide or copolyamide, which may be aliphatic or (partly) aromatic. The polyamide is preferably aliphatic. In a preferred embodiment of the multilayer film according to the invention, the polyamide layer (PA-1) and/or tie polyamide layer (PA-2) are based mutually independently on a polyamide or copolyamide selected from the group consisting of PA 4, PA 6, PA 7, PA 8, PA 9, PA 10, PA 11, , PA 12, PA 4.2, PA 6.6, PA 6.8, PA 6.9, PA 6.10, PA 6.12, PA 7.7, PA 8.8, PA 9.9, PA 10.9, PA 12.12, PA 6/6.6, PA 6.6/6, PA 6.2/6.2, and PA 6.6/6.9/6. Preferably, the composition of the polyamide layer (PA-1) and the polyamide layer (PA-2) is identical. PA 6 is particularly preferred.

The optionally present polyamide layers (PA-1) and/or (PA-2) preferably exhibit the same or different layer thicknesses of from 1.0 to 25 μm, more preferably 1.2 to 15 μm, still more preferably 1.5 to 10 μm, most preferably 1.8 to 7.5 μm and in particular of from 2.0 to 5.0 μm.

The heat-sealing layer (S) of the multilayer film according to the invention is preferably based on at least one polymer selected from the group comprising polyolefins, olefin copolymers and mixtures thereof. The polymers used for the production of the heat-sealing layer (S) are those approved for the production of layers which come into contact with foodstuffs. In a preferred embodiment, the heat-sealing layer (S) is based on at least one polyolefin selected from the group comprising m-polyethylene (m-PE), high density polyethylene (HDPE), low density polyethylene (LDPE), linear low density polyethylene (LLDPE), acrylic acid copolymer, in particular ionomer (preferably Surlyn®, e.g. at least in part as zinc salt), polypropylene (PP), propylene copolymer and mixtures thereof. Particularly preferably, the heat-sealing layer (S) is based on m-PE, LDPE or a mixture thereof. Sealing temperatures preferably lie in tie range from 100° C. to 140° C. The melting temperature of the heat-sealing layer (S) amounts preferably to from 90 to 140° C., particularly preferably 95° C. to 130° C. The heat-sealing layer (S) may be provided with conventional auxiliary substances such as antistatic agents, slip agents, antifogging agents, and/or spacers.

In a preferred embodiment of the multilayer film according to the invention, the heat-sealing layer (S) neither contains an additive with antifogging properties nor is it coated on its free surface with an additive with antifogging properties.

The heat-sealing layer (S) preferably has a thickness of from 1.0 to 100 μm, more preferably 2.5 μm to 50 μm, still more preferably 5.0 to 25 μm, most preferably 10 to 20 μm and in particular of from 12.5 to 17.5 μm.

Particularly preferred embodiments of the multilayer film according to the invention are summarised in the following table, wherein the multilayer film has the structure (T)//(Z)//(V)//(HV-1)//(PA-1)//(B)//(PA-2)//(HV-2)//(S):

| | | Layer thickness | | | | | |
|---|---|---|---|---|---|---|---|
| | Composition | | | more | | | |
| Layer | comprising | preferably | | preferably | | in particular | |
| (T) | Polypropylene and/or | 100-800 | μm | 140-600 | μm | 160-275 | μm |
| | propylene copolymer | | | | | | |
| (Z) | Polypropylene and/or | 50-750 | μm | 125-475 | μm | 175-425 | μm |
| | propylene copolymer | | | | | | |
| (V) | Polypropylene and/or | 1.0-100 | μm | 3.0-25 | μm | 5.0-15 | μm |
| | propylene copolymer | | | | | | |
| (HV-1) | Suitable coupling | 1.0-25 | μm | 1.5-10 | μm | 2.0-5.0 | μm |
| | agent | | | | | | |
| (PA-1) | Polyamide or | 1.0-25 | μm | 1.5-10 | μm | 2.0-5.0 | μm |
| | copolyamide | | | | | | |
| (B) | Ethylene/vinyl | 0.5-50 | μm | 1.5-15 | μm | 2.5-7.5 | μm |
| | alcohol copolymer | | | | | | |
| (PA-2) | Polyamide or | 1.0-25 | μm | 1.5-10 | μm | 2.0-5.0 | μm |
| | copolyamide | | | | | | |
| (HV-2) | Suitable coupling | 1.0-25 | μm | 1.5-10 | μm | 2.0-5.0 | μm |
| | agent | | | | | | |
| (S) | Polyethylene and/or | 1.0-100 | μm | 5.0-25 | μm | 12.5-17.5 | μm |
| | ethylene copolymer | | | | | | |

The multilayer film according to the invention may comprise further layers based on at least one polymer selected from the group comprising polyolefins, olefin copolymers, polyesters, polyamides, polystyrene (PS), polyethylene terephthalate (APET or CPET) or polyvinyl chloride.

The multilayer film according to the invention may be printed, wherein at least one layer of the multilayer film may be printed or coloured by the addition of additives such as organic or inorganic dyes and pigments.

In a preferred embodiment, the multilayer film according to the invention is transparent. For the purposes of the invention, the term “transparent” means that a packaged product may be looked at with the naked eye through the thermoformable multilayer film. The transparency is preferably quantified with the assistance of densitometers. Such methods are familiar to a person skilled in the art. Preferably, haze (%) may be measured as an optical value as a measure of transparency. Measurement of haze (%) is preferably performed to ASTM test standard D 1003-61m, procedure A, after calibration of the measuring instrument using haze standards of between 0.3 and 34% haze. An example of a suitable measuring instrument is a haze meter made by Byk-Gardner with an integrating sphere, said haze meter permitting integrated measurement of diffuse light transmittance values over a solid angle of from 8° to 160°. After thermoforming, the multilayer films according to the invention preferably exhibit haze, determined according to the above-described method, of less than 20%, more preferably less than 18%, still more preferably less than 15%, most preferably less than 10% and in particular less than 8%. Thermoforming preferably has no or only a slight influence on the optical properties of the multilayer films according to the invention (relative to material of the same thickness).

The multilayer film according to the invention is thermoformable. To assess the mechanical properties of the multilayer film according to the invention, it is possible, for example, to determine the secant modulus, 5% offset yield stress and tensile stress at yield (yield point) by means of the tensile test to DIN 53 455. In this context, the secant modulus is the slope of the stress-strain curve between 0.05 and 0.25% extension relative to the clamping cross-section, the 5% offset yield stress is the stress at 5% extension and the tensile stress at yield is the tensile stress at which the slope of the stress-strain curve becomes equal to zero for the first time. Samples 15 mm in width are investigated at 23° C., 50% relative atmospheric humidity and a test speed of 100 mm/min.

Preferably, the secant modulus determined using the above-stated method amounts to at least 650 N/mm², more preferably at least 700 N/mm², still more preferably at least 720 N/mm², most preferably at least 750 N/mm² and in particular at least 780 N/mm². In a preferred embodiment of the multilayer film according to the invention, the secant modulus amounts to at least 800 N/mm², more preferably at least 900 N/mm², still more preferably at least 1000 N/mm², most preferably it is in the range from 800 to 1500 N/mm², in particular from 1000 to 1200 N/mm². Particularly preferably, the secant modulus amounts to the above-stated values at a temperature of 100° C. The secant modulus correlates with the rigidity of a packaging tray. Preferably, a packaging tray may be thermoformed from the multilayer film according to the invention which, when heated, i.e. at 100° C., still exhibits sufficient mechanical stability for it already to exhibit significant rigidity (expressed by means of the secant modulus) when still heated.

Preferably, the 5% offset yield stress determined using the above-stated method amounts to at least 10 N/mm², more preferably at least 13 N/mm², still more preferably at least 16 N/mm², most preferably at least 19 N/mm² and in particular at least 21 N/mm². In a preferred embodiment of the multilayer film according to the invention, the 5% offset yield stress amounts to at least 22 N/mm², more preferably at least 25 N/mm², still more preferably at least 30 N/mm², most preferably it is in the range from 25 to 50 N/mm², in particular from 30 to 40 N/mm².

Preferably, the tensile stress at yield determined using the above-stated method is reached at at least 15 N/mm², more preferably at least 20 N/mm², still more preferably at least 22 N/mm², most preferably at least 24 N/mm² and in particular at least 26 N/mm². In a preferred embodiment of the multilayer film according to the invention, the tensile stress at yield is reached at at least 30 N/mm², more preferably at least 35 N/mm², still more preferably at least 40 N/mm², most preferably it is in the range from 35 to 60 N/mm², in particular from 40 to 50 N/mm².

In a preferred embodiment, the multilayer film according to the invention has a tensile modulus in the range from 1000 to 2500 MPa, more preferably 1050 to 2200 MPa, still more preferably 1100 to 1900 MPa, most preferably 1150 to 1700 MPa and in particular 1200 to 1500 MPa. The tensile modulus is preferably determined to ASTM test standard D638 (ISO 527).

In preferred embodiments 1-5, the film according to the invention, preferably in both the lengthwise and crosswise directions, exhibits one or more of the following parameters measured by tensile test to DIN EN ISO 527-3, preferably at least a secant modulus Eₛ within one of the following listed value ranges (mean calculated from three measurements; force transducer Fₘₐₓ: 2.5 kN; position sensor: crosshead; clamping length: 100 mm; a₀: in the range from 0.018-0.068 mm; bₙ: 15 mm; S₀: in the range from 0.27-1.02 mm²; preliminary force: 0.1 MPa; test speed 500 mm/min; start of E-modulus determination: 0.25%; end of E-modulus determination: 1.5%):

| Parameter | 1 | 2 | 3 | 4 | 5 |
|---|---|---|---|---|---|
| Eₛ [N/mm²] | 650-1600 | 750-1300 | 860-1060 | 880-1030 | 900-1000 |
| σ_{γ} [MPa] | 150-350 | 170-300 | 190-280 | 210-260 | 220-250 |
| ε_{γ} [%] | 5.0-15 | 6.5-13 | 7.9-11.5 | 8.5-10.5 | 9.0-10 |
| σ_{M} [MPa] | 240-410 | 260-390 | 280-370 | 290-360 | 300-350 |
| ε_{M} [%] | 480-750 | 500-720 | 520-700 | 540-680 | 560-660 |
| σ_{β}[MPa] | 90-400 | 100-380 | 110-370 | 130-350 | 150-300 |
| ε_{β} [%] | 350-800 | 400-750 | 450-700 | 500-650 | 550-600 |

Eₛ secant modulus to DIN EN ISO 527-3
σ_{γ}/ε_{γ} stress/strain in the linear range to DIN EN ISO 527-3
σ_{M}/ε_{M} stress/strain in the max. range to DIN EN ISO 527-3
σ_{β}/ε_{β} stress/strain at break to DIN EN ISO 527-3

Preferably, at least one of the pairs of parameters σ_{γ}/ε_{γ}, σ_{M}/ε_{M} or σ_{β}/ε_{β} is within the stated value ranges. Particularly preferably, all the parameters lie within the stated value ranges.

Preferably, the multilayer film according to the invention is suitable to be thermoformed by a thermoforming ratio of 1:2, more preferably 1:2.5, still more preferably 1:3, still more preferably 1:3.5, most preferably 1:4 and in particular 1:4.5. It is known to a person skilled in the art that the individual layer thickness of the multilayer film may be adapted to the intended thermoforming ratio, so that the material thickness is still sufficient afterwards even in the thermoformed areas.

In principle, the multilayer film according to the invention may additionally contain conventional additional or auxiliary substances independently in one or more layers. To vary the surface slip properties of the multilayer film, at least one layer may contain slip agents. The slip agents should preferably be contained in the backing layer (T) and/or the heat-sealing layer (S), but may additionally also be contained in at least one of the interlayers. In addition, the multilayer film may contain conventional stabilisers, antioxidants, plasticisers, processing aids, UV absorbers, fillers, flame retardants, antistatic agents, etc. in one or more layers. Such substances are known to a person skilled in the art.

The present invention also provides a process for the production of the above-described thermoformable multilayer films.

Production of the multilayer film according to the invention may comprise as a sub-step a blowing, flat film, coating, extrusion, coextrusion or corresponding coating or laminating process. Combinations of these processes are also possible.

The individual layers of the multilayer films according to the invention are preferably assembled neither purely sequentially nor in a single step. Particularly preferably, the individual layers of the multilayer film according to the invention are not assembled in a single coextrusion step.

According to the invention, production of the multilayer films is preferably effected by a consecutive process, in which first of all a multilayer film is produced, which comprises only some of the layers of the multilayer film according to the invention. This multilayer film preferably comprises
the bonding layer (V),
the coupling agent layer (HV-1) and/or the polyamide layer (PA-1),
the barrier layer (B),
the polyamide layer (PA-2) and/or the coupling agent layer (HV-2), and
the heat-sealing layer (S),
   but
not the backing layer (T),
nor the interlayer (Z).

The above-stated multilayer film is preferably produced by conventional flat film coextrusion or by blown film coextrusion, as described for example in U.S. Pat. No. 3,456,044. Such processes are known to a person skilled in the art. In this connection, reference may be made for example to A. L. Brody, K. S. Marsh, The Wiley Encyclopedia of Packaging Technology, Wiley-Interscience, 2nd edition (1997); W. Soroka, Fundamentals of Packaging Technology, Institute of Packaging Professionals (1995); J. Nentwig, Kunststoff-Folien, Hanser Fachbuch (2000); and S. E. M. Selke, Understanding Plastics Packaging Technology (Hanser Understanding Books), Hanser Gardner Publications (1997). Known production installations conventional in the art may be considered. In the case of flat film coextrusion, installations are preferably used which provide a rapid cooling option, such as large chill rolls.

The multilayer film produced in this way is then bonded, in accordance with the invention in the manner of extrusion lamination, to the backing layer (T) by extrusion of the interlayer (Z).

Therefore, one aspect of the invention relates to a process for the production of an above-described multilayer film, comprising the steps

(a) bringing the backing layer (T) together with a multilayer film comprising
the bonding layer (V),
the coupling agent layer (HV-1) and/or the polyamide layer (PA-1),
the barrier layer (B),
the polyamide layer (PA-2) and/or the coupling agent layer (HV-2), and
the heat-sealing layer (S); and

(b) extruding the interlayer (Z) between the backing layer (T) and the multilayer film.

Preferably, the multilayer film has the following layer sequences:
(V)//(HV-1)//(B)//(HV-2)//(S),
(V)//(PA-1)//(B)//(PA-2)//(S),
(V)//(PA-1)//(B)//(HV-2)//(S),
(V)//(HV-1)//(B)//(PA-2)//(S);
(V)//(HV-1)//(PA-1)//(B)//(HV-2)//(S),
(V)//(HV-1)//(PA-1)//(B)//(PA-2)//(S),
(V)//(HV-1)//(B)//(PA-2)//(HV-2)//(S),
(V)//(PA-1)//(B)//(PA-2)//(HV-2)//(S); or
(V)//(HV-1)//(PA-1)//(B)//(PA-2)//(HV-2)//(S).

In step (a), the multilayer film is preferably brought together with the backing layer (T) in such a way that the bonding layer (V) is facing the backing layer, so that in step (b) the interlayer (Z) is arranged between the backing layer (T) and the bonding layer (V) in the layer sequence of the laminate produced. In this way, the heat-sealing layer (S) comes to lie on one of the two outer sides of the laminate.

The extrusion temperature in step (b) is preferably in the range from 150 to 300° C., wherein a person skilled in the art may establish the ideal extrusion temperature by routine tests or according to the manufacturer's specifications depending on the composition of the polymer or polymer blend forming the interlayer (Z).

In order to provide the resulting laminate of backing layer (T), interlayer (Z) and multilayer film with sufficient mechanical strength, the process according to the invention preferably comprises the step
(c) exerting sufficient pressure on the laminate produced by steps (a) and (b) for the backing layer (T) and the multilayer film to be sufficiently bonded together.

The polymers used for the layer structure of the multilayer film are commercially obtainable and described sufficiently in the prior art. To produce multilayer films according to the invention, they are conventionally mixed in the form of pellets or granules so far as is necessary in conventional mixers and further processed by melting preferably with the assistance of extruders.

The multilayer film according to the invention is extremely well suited to the packaging of goods, preferably of foodstuffs, particularly preferably of perishable foodstuffs. The multilayer film may be used both for hot-fill applications and for heating package contents in the multilayer film proceeding as far as sterilisation. The multilayer film is suitable for the packaging of foodstuffs such as meat, fish, vegetables, fruit, milk products, smoked goods, ready meals, grain, cereals, bread and bakery products, and also of other goods, such as e.g. medical products.

The present invention therefore also provides the use of an above-described multilayer film for producing packaging, preferably packaging for a foodstuff.

The present invention also provides packaging made from the multilayer film according to the invention, preferably for foodstuffs, particularly preferably perishable foodstuffs. The packaging according to the invention comprises two packaging elements, of which at least one packaging element is an above-described multilayer film, which has been thermoformed.

Preferably, the first packaging element comprises a tray, which has been shaped by thermoforming, a cavity being formed between the first and the second packaging elements, wherein the first and second packaging elements are sealed together at the edges.

In a preferred embodiment, the second packaging element comprises a multilayer film with an overall layer thickness of less than 250 μm, more preferably less than 200 μm, still more preferably less than 100 μm, most preferably less than 75 μm and in particular less than 50 μm. This multilayer film making up the second packaging element is preferably not thermoformable.

Preferably, both packaging elements are transparent.

The following Examples serve to illustrate the invention, but are not limiting.

### EXAMPLE 1

The following multilayer film was produced:

| Type | Thickness | Polymer |
|---|---|---|
| (T) | 250 μm | Polypropylene |
| (Z) | 200 μm | Propylene copolymer |
| (V) | 9 μm | Propylene copolymer |
| (HV-1) | 3 μm | Olefin copolymer with grafted maleic anhydride |
| (PA-1) | 4 μm | Polyamide 6 |
| (B) | 5 μm | Ethylene/vinyl alcohol copolymer (38 mol % |
| | | EVOH) |
| (PA-2) | 4 μm | Polyamide 6 |
| (HV-2) | 3 μm | Olefin copolymer with grafted maleic anhydride |
| (S) | 15 μm | LDPE with 2 wt. % anti-blocking agent, 1 wt. % |
| | | further auxiliary substances |

To this end, first of all a multilayer film was produced by coextrusion from the bonding layer (V), the coupling agent layer (HV-1), the polyamide layer (PA-1), the barrier layer (B), the polyamide layer (PA-2), the coupling agent layer (HV-2) and the heat-sealing layer (S). The overall layer thickness of this multilayer film was 43 μm, such that the layer thickness of the barrier layer (B) relative to the overall layer thickness of the multilayer film amounted to 11.6%.

Then, the prefabricated backing layer (T) was bonded to the multilayer film by extrusion lamination, i.e. by extrusion of the interlayer (Z), and the resultant laminate was rolled.

A multilayer film of the above-stated composition was obtained, wherein the layer thickness of the barrier layer (B) amounted to 1.0% relative to the overall layer thickness of the multilayer film.

### EXAMPLES 2 TO 7

The following multilayer films were produced as in Example 1:

| | Layer thicknesses [μm] | | | | | | |
|---|---|---|---|---|---|---|---|
| Example | 2 | 3 | 4 | 5 | 6 | 7 | Composition |
| (T) | 250 | 250 | 250 | 250 | 180 | 180 | Polypropylene |
| (Z) | 400 | 382 | 272 | 197 | 177 | 102 | Propylene copolymer |
| (V) | 9 | 9 | 9 | 9 | 9 | 9 | Propylene copolymer |
| (HV-1) | 3 | 3 | 3 | 3 | 3 | 3 | Olefin copolymer with |
| | | | | | | | grafted maleic anhydride |
| (PA-1) | 4 | 4 | 4 | 4 | 4 | 4 | Polyamide 6 |
| (B) | 5 | 5 | 5 | 5 | 5 | 5 | Ethylene/vinyl alcohol |
| | | | | | | | copolymer (38 mol % |
| | | | | | | | EVOH) |
| (PA-2) | 4 | 4 | 4 | 4 | 4 | 4 | Polyamide 6 |
| (HV-2) | 3 | 3 | 3 | 3 | 3 | 3 | Olefin copolymer with |
| | | | | | | | grafted maleic anhydride |
| (S) | 15 | 15 | 15 | 15 | 15 | 15 | LDPE, 2 wt. % anti- |
| | | | | | | | blocking agent, 1 wt. % |
| | | | | | | | further auxiliary |
| | | | | | | | substances |
| Σ | 693 | 675 | 565 | 490 | 400 | 325 | |
| (B) [%] | 0.72 | 0.74 | 0.88 | 1.02 | 1.25 | 1.54 | |
| Eₛ | — | 1033 | 970 | 962 | 987 | 868 | |
| crosswise | | | | | | | |
| [N/mm²] | | | | | | | |
| Eₛ | — | 1050 | 954 | 972 | 1016 | 896 | |
| lengthwise | | | | | | | |
| [N/mm²] | | | | | | | |

The proportion, in percent, of the overall layer thickness (Σ) constituted by the layer thickness of the barrier layer (B) is stated in the above Table as “(B)[%]”. Moreover, for Examples 3 to 7, the secant modulus is stated in the crosswise and lengthwise directions, determined to DIN EN ISO 527-3 (mean calculated from three measurements; force transducer Fₘₐₓ: 2.5 kN; position sensor: crosshead; clamping length: 100 mm; a₀: in the range from 0.018-0.068 mm; b₀: 15 mm; S₀: in the range from 0.27-1.02 mm²; preliminary force: 0.1 MPa; test speed 500 mm/min; start of E-modulus determination: 0.25%; end of E-modulus determination: 1.5%)

1. A thermoformable multilayer film comprising
a backing layer (T) formed of a thermoplastic polyolefin, thermoplastic olefin copolymer or mixture thereof,
an interlayer (Z) formed of a thermoplastic polyolefin, thermoplastic olefin copolymer or mixture thereof,
a bonding layer (V),
a first coupling agent layer (HV-1) and/or a first polyamide layer (PA-1),
a gas- and/or aroma-tight barrier layer (B),
a second polyamide layer (PA-2) and/or a second coupling agent layer (HV-2), and
a heat-sealing layer (S),
wherein the layer thickness of the barrier layer (B) amounts to less than 3.0% of the overall layer thickness of the multilayer film.

2. A multilayer film according to claim 1, wherein the layer thickness of the interlayer (Z) amounts to at least 10% of the layer thickness of the backing layer (T).

3. A multilayer film according to claim 2, wherein the ratio of the layer thickness of the interlayer (Z) to the layer thickness of the backing layer (T) is in the range from 0.1:1 to 20:1.

4. A multilayer film according to claim 1, wherein the layer thickness of the interlayer (Z) is in the range from 50 to 750 μm.

5. A multilayer film according to claim 1, wherein the backing layer (T) and the interlayer (Z) are formed of the same or different materials selected from the group consisting of polypropylene, propylene copolymer and mixtures thereof.

6. A multilayer film according to claim 1, wherein the melt flow rates MFR of the polymers of which the backing layer (T), the interlayer (Z) and the bonding layer (V) are formed, determined in accordance with DIN ISO 1133 at 190° C. and 2.16 kg, behave according to the following sequence:
MFR (T)<MFR (Z)<MFR (V), or
MFR (T)<MFR (V)<MFR (Z).

7. A multilayer film according to claim 1, wherein the barrier layer (B) is formed of ethylene/vinyl alcohol copolymer or polyvinylidene chloride.

8. A multilayer film according to claim 1, wherein the layer thickness of the barrier layer (B) amounts to at most 10 μm.

9. A multilayer film according to claim 1, wherein the bonding layer (V) is formed of a thermoplastic polyolefin, thermoplastic olefin copolymer or mixture thereof.

10. A multilayer film according claim 1, wherein said multilayer film is transparent.

11. A multilayer film according to claim 1, having a secant modulus, determined to DIN EN ISO 527-3, of at least 650 N/mm².

12. A process for the production of the multilayer film of claim 1, comprising the steps of
(a) bringing the backing layer (T) together with a multilayer film comprising
the bonding layer (V),
the coupling agent layer (HV-1) and/or the polyamide layer (PA-1),
the barrier layer (B),
the polyamide layer (PA-2) and/or the coupling agent layer (HV-2), and
the heat-sealing layer (S); and
(b) extruding the interlayer (Z) between the backing layer (T) and the multilayer film.

13. The process of claim 12, comprising the further step of
(c) exerting sufficient pressure on the laminate produced by steps (a) and (b) for the backing layer (T) and the multilayer film to be bonded together.

14. A method of producing packaging which comprises producing said packaging of the thermoformable multilayer film of claim 1.

15. Method of claim 14, wherein said packaging is for a foodstuff.

16. Packaging comprising a thermoformed multilayer film of claim 1.

17. Packaging according to claim 16, comprising a further packaging element, wherein both the thermoformed multilayer film and the further packaging element are transparent.
